(19) United States
(12) Patent Application Publication
(10) Pub. No.: US 2018/0132445 A1
(43) Pub. Date: May 17, 2018

(54) CATTLE STALL SYSTEM

(71) Applicant: ARTEX BARN SOLUTIONS LTD., Abbotsford (CA)

(72) Inventor: John DE JONGE, Abbotsford (CA)

(21) Appl. No.: 15/815,268

(22) Filed: Nov. 16, 2017

Related U.S. Application Data
(60) Provisional application No. 62/423,104, filed on Nov. 16, 2016.

(51) Int. Cl. A01K 1/00

(52) U.S. Cl. CPC A01K 1/0011

(57) ABSTRACT

An animal stall system in which the individual stall divider members, that are made of a rigid material such as metal tubing, are connected to the framework of the stall system by intermediary resiliently flexible elastomeric members that provide a preferred amount of deflection of the stall divider member relative to the stall system framework on which the divider members are connected, thereby providing increased comfort to the animals.

### FIELD OF THE INVENTION

This invention relates to a cattle handling system and, more particularly, to an improved cattle handling apparatus used for separating cattle stalls within a barn in order to allow for individual stalls.

### BACKGROUND OF THE INVENTION

Typically, in dairy operations, cows are sheltered within a barn or a barn may be available in the event of inclement weather or otherwise. The cows may rest or may be fed and milked within the barn. A further area is generally provided for allowing the cows to rest if they are not eating. The rest area is divided into stalls to separate the resting cows. This prevents interference between the resting cows. The stalls are arranged on an elongate concrete slab which runs the length of the barn within which the cows are located and is of a width that allows the cows to stand or lie such that the manure from the resting cows is deposited outside the width of the elongate slab for convenience in manure gathering and disposition. The slab is covered with bedding of an appropriate nature, such as compost, hay, sawdust, sand and the like and may be underlain with a rubber mattress, all of which is intended to provide for the comfort of the cows.

An example of a prior art installation of stall dividers includes a plurality of vertical hollow metallic members that are anchored to the concrete slab and aligned and spaced a predetermined distance apart. Brackets are mounted on the vertical members at desired vertical positions to which the actual stall divider members are connected and extend horizontally outward. The stall divider members extend generally normal to the longitudinal center line of the slab. In other variations of the prior art, the vertical members are spaced further apart and one or more horizontal members are provided to span the gap between the vertical members. Brackets are mounted on the horizontal members, and the individual stall divider members are attached to the brackets. In the prior art installations of stall dividers, the vertical members, horizontal members, the individual stall divider members, and the brackets that connect these members to the others are of a rigid material such that the connections between these members are themselves rigid. Thus, there is very little flex of the individual stall divider members with respect to the remainder of the stall divider installation, which has an adverse impact on cow comfort. Some examples of a rigid prior art stall dividers are described in U.S. Pat. No. 7,918,189 to De Jonge, et al.

Others in the prior art have recognized the disadvantage of rigid stall dividers and have attempted to solve the problem by producing the actual stall dividers out of a resiliently flexible material. These types of flexible stall dividers have been touted as the newest developments in the industry. However, the problem with these flexible stall divider members is that they are too flexible and provide too much lateral yield. While this may be great for cow comfort, it is not so good for the management and health of the animals. The problem of inflexible stall dividers is well recognized but the solutions thus far have been to use stall divider members that are made out of a flexible material.

### SUMMARY OF THE INVENTION

According to one aspect of the invention, there is disclosed an animal stall system in which the individual stall divider members, that are made of a rigid material such as metal tubing, are connected to the framework of the stall system by intermediary resiliently flexible elastomeric members that provide a preferred amount of deflection of the stall divider member relative to the stall system framework on which the divider members are connected, thereby providing increased comfort to the animals.

Accordingly, in some aspects, the present invention provides a cattle stall divider system comprising a stall divider framework, a plurality of individual stall divider members mounted to the framework to define individual animal spaces, and a plurality of resiliently flexible elastomeric members located in between the individual stall divider members and the framework at each point of contact between said stall divider members and said framework.

In some embodiments, the elastomeric members may comprise a material having a hardness in the range of 70 to 100 Durometers (Shore A scale).

In accordance with another aspect of the invention, there is provided a cattle stall divider system comprising a stall divider framework, a plurality of individual stall divider members mounted to the framework to define individual animal spaces, and at least one resiliently flexible elastomeric member located at each point of contact between the individual stall divider members and the framework.

The cattle stall divider system may include a bracket disposed at each of the points of contact. The bracket may include the at least one resiliently flexible elastomeric member. The bracket may include a plate member and a plate abutting opposing sides of the at least one resiliently flexible elastomeric member, the plate member being dimensioned for attaching to the framework, the plate being attached to one of the stall divider members. The at least one resiliently flexible elastomeric member may include a rectangular elastomeric member. The rectangular elastomeric member may include a material having a hardness in the range of 70 to 100 Durometers (Shore A scale). The rectangular elastomeric member may include a material having a hardness in the range of 75 to 85 Durometers (Shore A scale).

The bracket may include an enclosure for housing the at least one resiliently flexible elastomeric member. Each of the stall divider members may include a mounting portion dimensioned for passing through the enclosure, the mounting portion comprising a narrowed portion dimensioned to be housed within the enclosure. The enclosure may house a plurality of the resiliently flexible elastomeric members surrounding the narrowed portion such that the narrowed portion is permitted resiliently constrained movement within the enclosure. The cross-sectional shape of the enclosure may be square, the cross-sectional shape of the narrowed portion may be square, and the cross-sectional shape of each of the plurality of resiliently flexible elastomeric members may be round. Each of the resiliently flexible elastomeric members may be disposed within the enclosure at one corner thereof and may be disposed adjacent a side of the narrowed portion. Each of the resiliently flexible elastomeric members may be cylindrical. Each of the resiliently flexible elastomeric members may be tube-shaped.

### BRIEF DESCRIPTION OF THE DRAWINGS

Specific embodiments of the invention will now be described, by way of example only, with the use of drawings in which:

FIG. 1 is a perspective view of a stall system in accordance with a first embodiment of the present invention;

FIG. 2 is a side close-up view of a stall divider member mounted on a stall framework of the embodiment in FIG. 1;

FIG. 3 is a perspective close-up view of resiliently flexible mounting brackets connected to the stall divider member of the embodiment in FIG. 1;

FIG. 4 is a side close-up view of the resiliently flexible mounting brackets shown in FIG. 3;

FIG. 5 is a perspective view of the resilient flexible mounting brackets shown in FIG. 3 as mounted on horizontal members of the stall framework;

FIG. 6 is a perspective view of a stall system in accordance with a second embodiment of the invention, showing a mounting portion of a stall divider member mounted to horizontal members of the stall framework by a pair of dissimilar resiliently flexible brackets;

FIG. 7 is a perspective close-up view of the resiliently flexible brackets shown in FIG. 6, with an enclosure of the lower bracket removed to reveal elastomeric members;

FIG. 8 is a side close-up view of the resiliently flexible brackets shown in FIG. 6, showing sectional indications for FIGS. 9 and 10;

FIG. 9 is a sectional view of one resiliently flexible bracket along the line A-A of FIG. 8;

FIG. 10 is a sectional view of the pair of resiliently flexible brackets along the line B-B of FIG. 8;

FIG. 11 is a perspective view of a stall system in accordance with a third embodiment of the invention, showing a mounting portion of a stall divider member mounted to horizontal members of the stall framework by a pair of similar resiliently flexible brackets; and

FIG. 12 is a perspective view of a stall system in accordance with a fourth embodiment of the invention, showing a mounting portion of a stall divider member mounted to a vertical support of the stall framework by a pair of similar resiliently flexible brackets.

### DETAILED DESCRIPTION OF SPECIFIC EMBODIMENTS

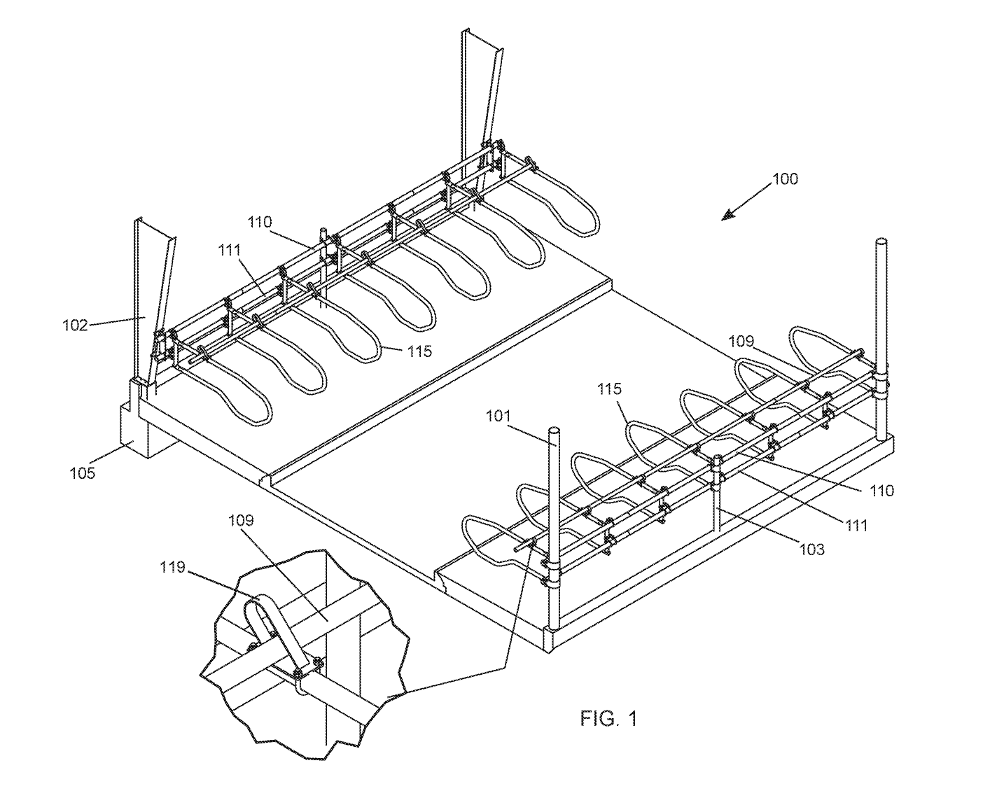

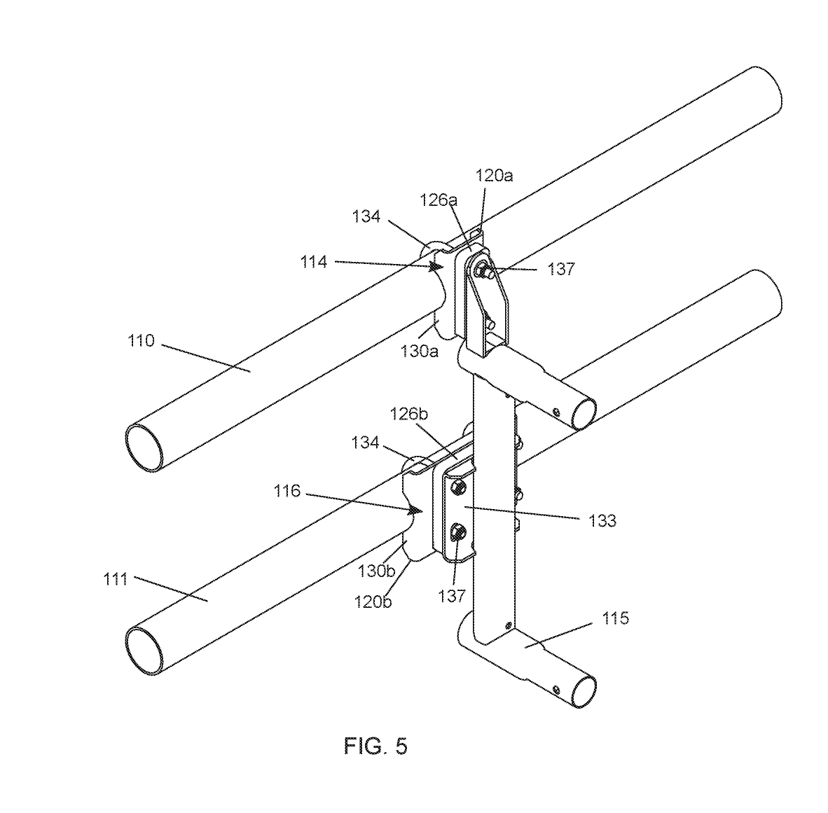

Referring now to the drawings, a cattle stall system according to a first embodiment of the present invention is shown generally at 100 in FIG. 1. Referring to FIGS. 1-5, the stall system 100 includes a plurality of vertical supports such as for example, end posts 101, vertical members 102, or intermediate posts 103. These vertical supports are connected to or embedded in the floor of the barn, such as for example, concrete slab 105. In the illustrated embodiment, tubular metallic horizontal members 110 and 111 extend between vertical supports. Together, the vertical supports and the horizontal members provide a framework to which individual stall divider members 115 are mounted at horizontal intervals to define a space there between, each suitable for accommodating one animal. The spacing of the individual stall dividers is generally well known in the art. To the horizontal members are mounted flexibly resilient mounting brackets, such as for example brackets 114 and 116, for connecting the individual stall divider members 115 to the framework of the stall divider installation.

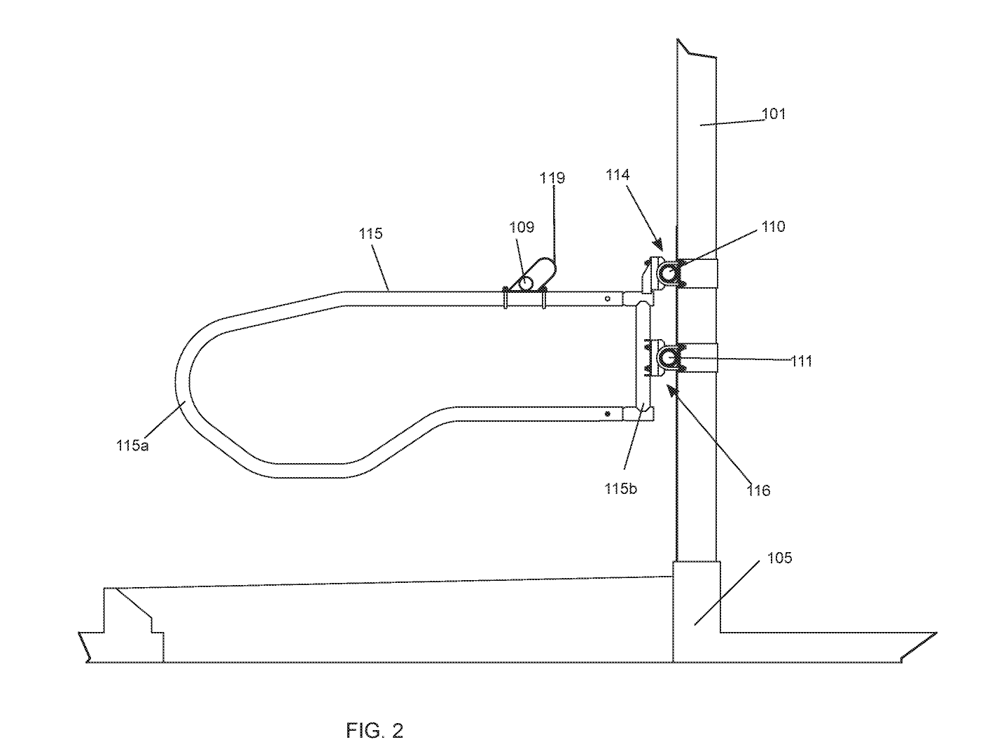

With reference to FIG. 2, the stall divider members 115 in the illustrated embodiment comprise of a modular construction where in the main stall divider portion 115a is removably connected to a mounting portion 115b, which is mounted to the stall framework by the brackets 114 and 116. However, the stall divider members 115 may be of a unitary construction. And while the illustrated embodiment shows a modular construction, the stall divider member will be referred to as one unit and the mounting portion 115b in the figures will nevertheless be referred to as stall divider member 115 for convenience.

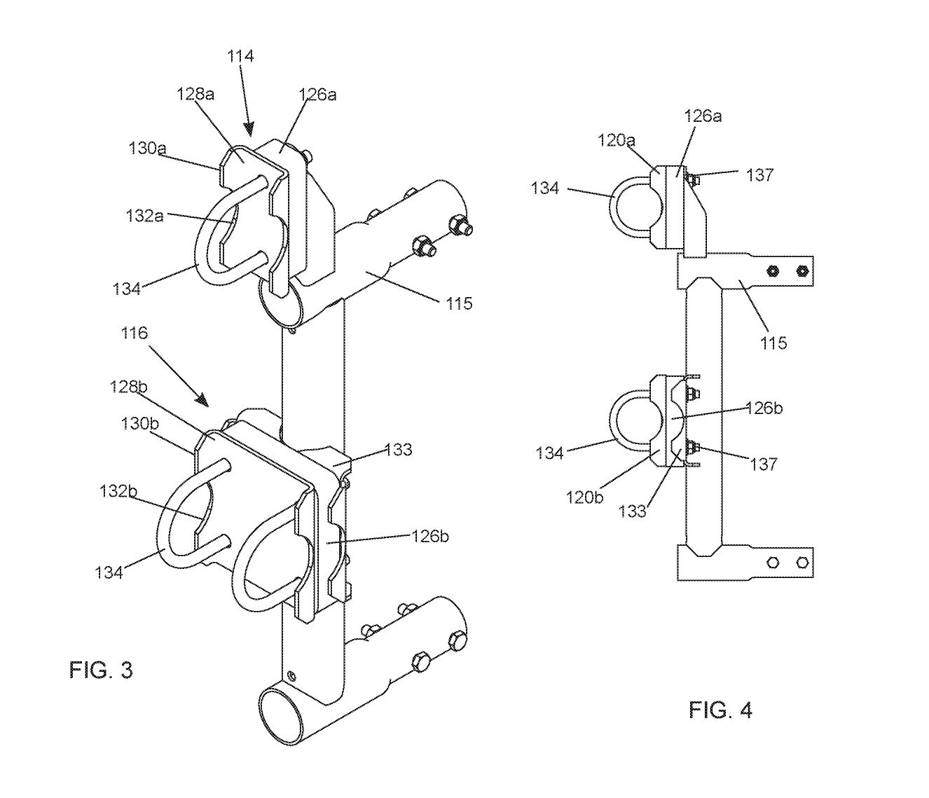

Referring to FIGS. 3-5, there are shown of close-up views of the connection structures between the individual stall divider members and the framework of the stall installation, which in the illustrated embodiment, are the resiliently flexible brackets 114 and 116 that connect the individual stall divider members 115 with horizontal members 110 and 111 of the framework.

Generally, resiliently flexible brackets 114 and 116 comprise framework connecting portion 120 and a rectangular elastomeric block or member 126. The framework connecting portion 120a of bracket 114 in the illustrated embodiment comprises a plate member 128a that abuts the rectangular elastomeric member 126a, and lateral flange portions 130a extending away from the elastomeric member 126a, and each defining a round portion 132a for accommodating a tubular member therein and thus for locating horizontal member 110. U-bolt 134 envelops a circumference of said horizontal member 110 and extends through the elastomeric member 126a and through a complementary portion of stall divider member 115, said portion having a planar surface forming a plate that abuts the elastomeric member 126a. The threaded ends of the U-bolt 134 are engaged by nuts 137 to tighten said horizontal member 110 against the plate member 128a, and thereby connect stall divider member 115 to the framework of the stall installation.

The framework connecting portion 120b of bracket 116 in the illustrated embodiment comprises a plate member 128b that abuts the rectangular elastomeric member 126b, and lateral flange portions 130b extending away from the elastomeric member 126b, and each defining a round portion 132b for accommodating a tubular member therein and thus for locating horizontal member 111. U-bolts 134 envelop a circumference of said horizontal member and extend through the elastomeric member 126b and through a plate 133 that is affixed to a complementary portion of stall divider member 115. The threaded ends of the U-bolts 134 are engaged by nuts 137 to tighten said horizontal member against the plate member 128b , and thereby connect stall divider member 115 to the framework of stall installation.

The rectangular elastomeric members 126 (126a in the case of bracket 114, and 126b in the case of bracket 116) are thus sandwiched between the framework connecting portion 120 and a portion of the stall divider member 115 to provide a resiliently flexible connection between the stall divider members 115 and the framework of the stall installation. Thereby the elastomeric members 126 allow lateral deflection of the stall divider members 115 when an animal bumps or leans against the stall divider. In general, the rectangular elastomeric member 126 (including 126a and 126b) may have any suitable shape, provided its shape is sufficiently rectangular to accommodate abutment to the plate member 128 (including 128a and 128b) and abutment to the plate 133 (or, in the case of the bracket 114, the plate attached to the complementary portion of stall divider member 115).

The rectangular elastomeric members 126 are preferably made of an elastomeric material having a hardness within the range of 70-100 Durometers (Shore A scale), and more preferably 75-85 Durometers. A material that is significantly softer provides too much yield and lateral movement of the stall divider member 115, whereas the material that is significantly harder provides too little yield and behaves much like the rigid tubular material of the prior art.

Also with reference to FIG. 1, the stall system 100 in the illustrated embodiment includes a horizontal neck rail 109 that spans across several adjacent stall dividers. In the prior art, the neck rail is rigid and typically comprises of a tubular metal. However, in the illustrated embodiment of the present invention, the neck rail 109 comprises an elongate elastomeric rod, that may be most efficiently produced as an extrusion. The elastomeric composition provides a measure of flexibility in the neck rail 109 for additional animal comfort. While the stall system 100 is illustrated with the neck rail 109, it may be omitted in some embodiments of the present invention or a conventional rigid tubular metal neck rail may be used. Regardless of whether a rigid or elastomeric neck rail 109 is used in an embodiment of the present invention, the neck rail 109 is retained in place on each stall divider by a bracket 119 which provides a degree of movement of the neck rail 109 relative to the stall divider member 115 such that the neck rail 109 may be said to be floating. Advantageously, this allows for the deflection of the stall divider member 115 without it being restrained by a rigid connection to the neck rail 109. As shown in FIG. 1, the bracket 119 in the first embodiment is oval-shaped at a terminal end thereof. While not shown in the figures, the ends of the neck rail 109 are also provided with a movable mount that allow for a degree of movement in up-down and fore-aft direction, but not lateral sliding.

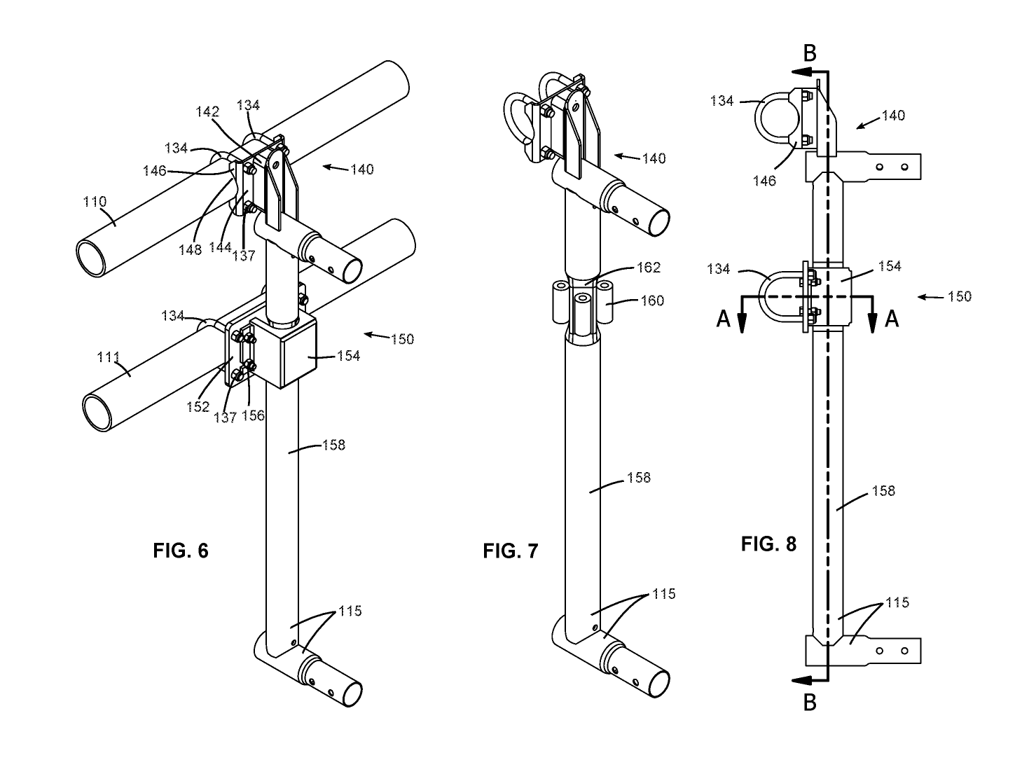

Referring to FIG. 6, a stall system in accordance with a second embodiment of the present invention includes a bracket 140 containing a rectangular elastomeric member 142 and being disposed at a point of contact between the framework and a stall divider member 115. The bracket 140 differs from the bracket 114 (FIGS. 3-5) principally by making use of a pair of parallel, spaced apart U-bolts 134 disposed on either side of the elastomeric member 142, rather than the single U-bolt 134 of bracket 114 (FIGS. 3-5). In the second embodiment, the U-bolts 134 are attached by nuts 137 to a plate member 144 of the bracket 140 that abuts the elastomeric member 142. Lateral flange portions 146 extend away from the elastomeric member 142 to define round portions 148 for accommodating a tubular member therein and thus for locating the horizontal member 110. U-bolt 134 envelops a circumference of said horizontal member 110 of the framework and extends through the elastomeric member 142 and through a complementary portion of stall divider member 115, said portion having a planar surface forming a plate that abuts the elastomeric member 142. The threaded ends of the U-bolt 134 are engaged by nuts 137 to tighten said horizontal member 110 against the plate member 144, and thereby connect stall divider member 115 to the framework of the stall installation. The rectangular elastomeric member 142 may generally have any suitable shape, provided its shape is sufficiently rectangular to accommodate abutment to the plate member 144 and abutment to the plate attached to the complementary portion of stall divider member 115 as shown in FIG. 6.

As in the first embodiment, the rectangular elastomeric members 142 of the second embodiment are preferably made of an elastomeric material having a hardness within the range of 70-100 Durometers, and more preferably 75-85 Durometers.

Still referring to FIG. 6, the stall system of the second embodiment also includes the bracket 150 disposed at a point of contact between the framework and the stall divider member 115. The bracket 150 includes a plate member 152 for receiving a pair of U-bolts 134 attached by the nuts 137 so as to locate and attach the horizontal member 111. The bracket 150 includes an enclosure 154 that is rigidly attached to the plate member 152 by fasteners 156.

In accordance with the second embodiment, the mounting portion 158 of a stall divider member 115 (not fully shown in FIG. 6) is resiliently mounted to the horizontal members 110 and 111 by the resiliently flexible brackets 140 and 150. As in the first embodiment, the stall divider member(s) 115 may be of modular or unitary construction.

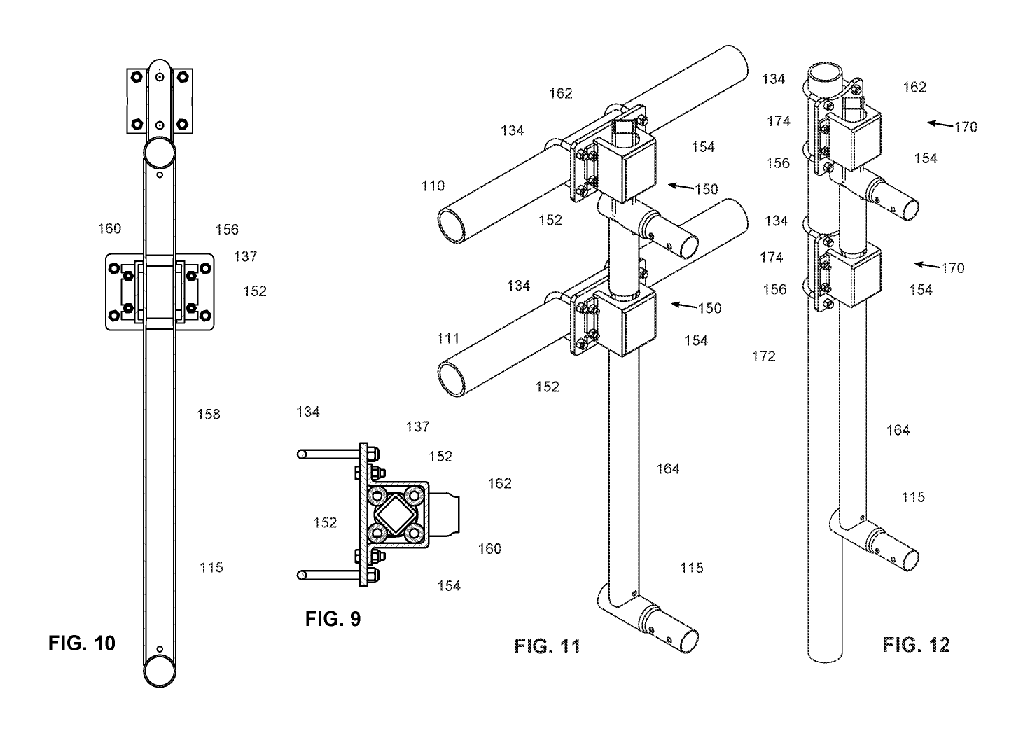

Referring to FIGS. 6-10, the enclosure 154 is dimensioned to house elastomeric members 160 at a narrowed portion 162 of the mounting portion 158 where it passes through the enclosure 154. While the narrowed portion 162 may be an integral portion of the mounting portion 158, it may also in some embodiments be a separate component that is attached to the mounting portion 158, such as by welding during manufacturing, fastening during manufacturing or assembling, or otherwise attached to the remainder of the mounting portion 158. Other variations are possible. As best seen in FIGS. 7 and 9, the elastomeric members 160 are preferably rounded in cross-sectional shape while each of the narrowed portion 162 and the enclosure 154 preferably has a rectangular cross-sectional shape, with the elastomeric members 160 preferably being disposed at corners within the enclosure 154 adjacent to sides of the narrowed portion 162. However, in any general any suitable combination of cross-sectional shapes and relative placements of the enclosure 154, elastomeric members 160 and narrowed portion 162 is within the scope contemplated by the present invention, provided the selected combination provides internal surfaces for the elastomeric members 160 to react against within the enclosure 154. In general, the enclosure 154 can have any external geometry. While the elastomeric members 160 of FIGS. 7 and 9 are shown tubular, in a variation the elastomeric members 160 may be cylindrical and non-annular for example. The elasticity and hardness of the elastomeric members 160 may be varied to accommodate a variety of combinations of material, cross-sectional shape, inner diameter, outer diameter and other geometrical features of the elastomeric members 160, for example. In variations the elastomeric members 160 may have a hardness in the range of 70-100 Durometers, for example.

In operation, the narrowed portion 162 of the mounting portion 158 is housed within and passes through the enclosure 154, such that the bracket 150 permits the narrowed portion 162 to move within the enclosure 154, while such movement is resiliently constrained by the elastomeric members 160 that surround the narrowed portion 162 within the enclosure 154. Such constrained movement of the narrowed portion 162 translates generally to permit resiliently constrained movement of the stall divider member 115.

Referring to FIG. 11, a stall system in accordance with a third embodiment of the present invention includes a pair of similar resiliently flexible brackets 150 disposed at a point of contact between the framework and a stall divider member 115. In accordance with the third embodiment, the mounting portion 164 of a stall divider member 115 (not fully shown in FIG. 11) is resiliently mounted to the horizontal members 110 and 111 by the resiliently flexible brackets 150. As in the first and second embodiments, the stall divider member(s) 115 may be of modular or unitary construction. In the third embodiment, however, the mounting portion 164 includes two, collinear narrowed portions 162. As shown in FIG. 11, each narrowed portion 162 aligns with one bracket 150 where the mounting portion 164 passes through the enclosures 154. The U-bolts 134, plate members 152, enclosures 154 and associated fasteners are preferably identical between the second and third embodiments. In accordance with the third embodiment, the enclosure 154 is dimensioned to house elastomeric members 160 at a narrowed portion 162 of the mounting portion 158 for permitting resiliently constrained movement of the narrowed portion 158 within the enclosure 154 in a manner similar or analogous to the enclosures 154 of the second embodiment. Accordingly, the elastomeric members 160 may be cylindrical, including possibly being tube-shaped, for example. The third embodiment advantageously has the attribute of ease of manufacturing and a consequent lowering of manufacturing cost, due to the re-use of the same bracket 150.

Referring to FIG. 12, a stall system in accordance with a fourth embodiment of the present invention includes a pair of similar resiliently flexible brackets 170 disposed at points of contact between the framework and the stall divider member 115. In accordance with the fourth embodiment, the mounting portion 164 of a stall divider member 115 (not fully shown in FIG. 12) is resiliently mounted to a vertical support 172 by the resiliently flexible brackets 170. The vertical support 172 may be an end post 101 (FIG. 1), vertical member 102 (FIG. 1), intermediate post 103 (FIG. 1) or other vertical member of the framework, for example. As in the first to third embodiments, the stall divider member(s) 115 may be of modular or unitary construction. The resiliently flexible bracket 170 of the fourth embodiment includes the plate member 174, which is oriented to horizontally receive the U-bolts 134 for attachment to the vertical support 172. The plate member 174 is dimensioned to rigidly attach to the enclosure 154 by the fasteners 156. While not visible in FIG. 12, the enclosure 154 is dimensioned to house elastomeric members 160 at a narrowed portion 162 of the mounting portion 158 for permitting resiliently constrained movement of the narrowed portion 158 within the enclosure 154, in a manner similar or analogous to the enclosure 154 of the second and third embodiments. Accordingly, the elastomeric members 160 may be cylindrical, including possibly being tube-shaped, for example. Analogous to the second and third embodiments, the cross-sectional shape of each of the narrowed portion 162 and the enclosure 154 is preferably square while the cross-sectional shape of the elastomeric members 160 are preferably round, with the elastomeric members 160 preferably being disposed at corners within the enclosure 154 adjacent to sides of the narrowed portion 162. Nonetheless, other combinations of cross-sectional shapes and placements are possible and are within the scope contemplated by the present invention.

In a variation of the fourth embodiment, the enclosure 154 may be dimensioned for symmetrical arrangement of the fasteners 156, such that the plate member 174 can be manufactured to be identical to the plate member 152 of the second and third embodiments, yet assembled for horizontal placement of the U-bolts 134. In this manner, the components of the third and fourth embodiments can be identical such that the third and fourth embodiments are interchangeable and any combination of the third and fourth embodiments can be assembled according to the framework in use.

While FIGS. 6 and 8-12 show the plate member 152 fastened to the enclosure 154 by the fasteners 156, in general the plate member 152 and the enclosure 154 may be attached to each other by any suitable technique, including by any suitable fastening system, being integrally connected to each other, being interlocking, or other attachment technique, for example,

While FIGS. 11 and 12 show the narrowed portions 162 passing entirely through the enclosure 154, in some embodiments the upper narrowed portions 162 may terminate inside the enclosure 154. Such embodiments typically include a bushing, bearing or other support structure (not shown) to support and locate the terminal end of the narrowed portion 162. Such support structure may be made of plastic, for example, or other suitable material(s).

While separately enumerated embodiments have been illustrated and described herein for ease of understanding, the invention contemplates that various embodiments and features thereof may be suitably combined in any desired manner. For example, the resiliently flexible brackets 114, 116, 140, 150 and 170 may be employed in any desired combination, including combinations of dissimilar brackets and combinations of similar brackets, in accordance with any framework dimensions. Furthermore, the invention contemplates that one or more elastomeric members similar or functionally equivalent to elastomeric member(s) 126, 142 and/or 160 are mounted as an intermediary member at each point of connection between a stall divider member and the stall framework so as to provide a resiliently flexible mounting to enable a desired amount of lateral deflection of the stall divider relative to the framework.

While specific embodiments of the invention have been described, such embodiments are illustrative of the invention only and should not be taken as limiting its scope. In light of the present disclosure, many modifications will occur to those skilled in the art to which the invention relates, and the invention, therefore, should be construed in accordance with the accompanying claims.

1. A cattle stall divider system comprising a stall divider framework, a plurality of individual stall divider members mounted to the framework to define individual animal spaces, and at least one resiliently flexible elastomeric member located at each point of contact between the individual stall divider members and the framework.

2. The cattle stall divider system of claim 1 comprising a bracket disposed at said each point of contact, the bracket comprising said at least one resiliently flexible elastomeric member.

3. The cattle stall divider system of claim 2 wherein the bracket comprises a plate member and a plate abutting opposing sides of said at least one resiliently flexible elastomeric member, the plate member being dimensioned for attaching to the framework, the plate being attached to one said stall divider member.

4. (canceled)

5. The cattle stall divider system of claim 1 wherein said at least one resiliently flexible elastomeric member comprises a rectangular elastomeric member.

6. The cattle stall divider system of claim 2 wherein said at least one resiliently flexible elastomeric member comprises a rectangular elastomeric member.

7. The cattle stall divider s stem of claim 3 wherein said at least one resiliently flexible elastomeric member comprises a rectangular elastomeric member.

8. The cattle stall divider system according to claim 4 wherein the rectangular elastomeric member comprises a material having a hardness in the range of 70 to 100 Durometers.

9. The cattle stall divider system according to claim 4 wherein the rectangular elastomeric member comprises a material having a hardness in the range of 75 to 85 Durometers.

10. The cattle stall divider system of claim 2 wherein the bracket comprises an enclosure for housing said at least one resiliently flexible elastomeric member.

11. The cattle stall divider s stem of claim 10 wherein each said stall divider member comprises a mounting portion dimensioned for passing through the enclosure, the mounting portion comprising a narrowed portion dimensioned to be housed within the enclosure.

12. (canceled)

13. The cattle stall divider system of claim 11 wherein the enclosure houses a plurality of said resiliently flexible elastomeric permitted resiliently constrained movement within the enclosure.

14. The cattle stall divider system of claim 13 wherein the cross-sectional shape of the enclosure is square, the cross-sectional shape of the narrowed portion is square, and the cross-sectional shape of each of the plurality of resiliently flexible elastomeric members is round.

15. The cattle stall divider system of claim 14 wherein said each resiliently flexible elastomeric member is disposed within the enclosure at one corner thereof and is disposed adjacent a side of the narrowed portion.

16. The cattle stall divider system of claim 10 wherein said each resiliently flexible elastomeric member is cylindrical.

17. The cattle stall divider system of claim 11 wherein said each resiliently flexible elastomeric member is cylindrical.

18. The cattle stall divider system of claim 13 wherein said each resiliently flexible elastomeric member is cylindrical.

19. The cattle stall divider system of claim 16 wherein said each resiliently flexible elastomeric member is tube-shaped.

20. The cattle stall divider system of claim 17 wherein said each resiliently flexible elastomeric member is tube-shaped.

21. The cattle stall divider system of claim 18 wherein said each resiliently flexible elastomeric member is tube-shaped.

22. The cattle stall divider system of claim 19 wherein said each resiliently flexible elastomeric member is tube-shaped.
